(19) United States
(12) Patent Application Publication
(10) Pub. No.: US 2006/0002127 A1
(43) Pub. Date: Jan. 5, 2006

(54) Lens arrangement and a motor vehicle headlight or motor vehicle light having a lens arrangement of this type

(75) Inventors: Ralf Ackermann, Kirchentellinsfurt (DE); Hermann Kellermann, Reutlingen (DE); Christian Buchberger, Reutlingen (DE)

Correspondence Address: CENTRAL COAST PATENT AGENCY, PO BOX 187, AROMAS, CA, 95004, US

(73) Assignee: Automotive Lighting Reutlingen GmbH

(21) Appl. No.: 11/168,237

(22) Filed: Jun. 27, 2005

(30) Foreign Application Priority Data
Jul. 1, 2004 (DE) 10 2004 031 858.1

(51) Int. Cl. F21V 1/00

(52) U.S. Cl. 362/509

(57) ABSTRACT

The present invention relates to a lens arrangement (7) for a motor vehicle headlight (7) or a motor vehicle light having at least one light source (5.1, 5.2, 5.3) that in the switched-on state emits light, the lens arrangement (7) including a plurality of individual lenses (7.1, 7.2, 7.3) that are arranged in the beam path of the light. In order to be able to manufacture and assemble the lens arrangement (7) as simply and as cost-effectively as possible, and so that the lens arrangement has the most reserved appearance possible, the present invention proposes that a light-emitting surface (7.4) of the lens arrangement (7) have a constant curvature. Advantageously, the curvature of the light-emitting surface (7.4) has no points of inflection. A light-receiving surface (7.5) of the lens arrangement (7) is advantageously configured such that, in combination with the light-emitting surface (7.4), specifiable projection characteristics of the individual lenses (7.1, 7.2, 7.3) result.

### STATE OF THE ART

The present invention relates to a lens arrangement for a motor vehicle headlight or a motor vehicle light having at least one light source that in the switched-on state emits light. The lens arrangement includes a plurality of individual lenses that are arranged in the beam path of the light.

In addition, the present invention relates to a motor vehicle headlight and a motor vehicle light, which include at least one light source that in the switched-on state emits light and one lens arrangement that has a plurality of individual of lenses that are arranged in the beam path of the light.

A motor vehicle headlight of the type mentioned above is known, by way of example, from EP 1 085 254 A2.

In the case of the lens arrangement of the headlight described above, all the individual lenses have the identical configuration seen from a purely external point of view. In the case of the familiar headlight, it is a question of giving the front end of the vehicle a novel appearance on the basis of the many individual lenses of the lens arrangement that are arranged next to each other and are visible from the outside. This particular appearance is achieved due to the fact that the light-emitting surface of the lens arrangement in the area of each individual lens is curved outwards in a convex manner. In addition, around each individual lenses is configured a sharply highlighted frame area, which, together with the individual lenses, is an integral component of the lens arrangement. Therefore, the light-emitting surface of the lens arrangement of the familiar headlight, taken in its entirety, has a multiplicity of creases and breaks. Light that is emitted by the light source of the headlight may be influenced by such creases and breaks in unexpected ways, it can escape from the lens arrangement, and it can result in the irritation and even the endangerment of oncoming traffic participants. In addition, these creases and breaks can result in undesirable light reflections falling onto the lens arrangement from outside. To avoid this, the entire lens arrangement with the exception of the individual lenses is provided with an opaque coating.

Apart from its determinative, dominating, and even unconventional appearance, the familiar lens arrangement also has the disadvantage that it is difficult and expensive to manufacture, for example, due to the necessity of applying a coating.

Proceeding on the basis of this prior art, the present invention has the objective of configuring and refining a lens arrangement of the type cited above such that it can be manufactured as simply and as cost-effectively as possible and such that it has the most reserved appearance possible.

To achieve this objective, starting from the lens arrangement of the type cited above, it is proposed that a light-emitting surface of the lens arrangement have a constant curvature.

Advantages of the Present Invention

Therefore, the outwards-oriented light-emitting surface of the lens arrangement has neither creases nor breaks. In other words, the first derivative of the surface curve of the light-emitting surface has a constant curve, i.e., no creases. The lens arrangement according to the present invention having a light-emitting surface without creases or breaks can be manufactured in a simple manner. In addition, the lens arrangement has an appearance that is appropriate, restrained, and uniform over its entire light-emitting surface, as a result of which entirely new possibilities are made available to designers in configuring the vehicle front end.

The lens arrangement is also termed a lens array. The individual lenses of the lens arrangement may be configured in any way, specifically as Fresnel lenses or as convex or concave free-form lenses.

According to one advantageous refinement of the present invention, it is proposed that the curvature of the light-emitting surface have no points of inflection. In other words, the second derivative of the surface curve of the light-emitting surface has no zero points. The light-emitting surface therefore is constituted as a surface that curves in only one direction.

According to one preferred embodiment of the present invention, it is proposed that a light-receiving surface of the lens arrangement is configured such that, in combination with the light-emitting surface of the lens arrangement, specifiable projection characteristics of the individual lenses result. Because the curve of the light-emitting surface of the lens arrangement is also stipulated by the present invention in the area of the individual lenses, the desired projection characteristics of the individual lenses are achieved mainly through a corresponding shaping of the light-receiving surface of the lens arrangement. In this context, the areas of the light-receiving surface of the lens arrangement that are assigned to a specific individual lens are adjusted to the corresponding areas of the light-emitting surface. It is conceivable that, although each individual lens of the lens arrangement may include different areas of the light-emitting surface, the individual lenses may nevertheless use a common area of the light-receiving surface or at least fewer light-receiving surface areas than the number of individual lenses that are present in the lens arrangement. Conversely, it would also be conceivable to provide several different areas for the individual lenses on the light-receiving surface of the lens arrangement, each individual lens preferably having its own area of the light-receiving surface, a common area on the light-emitting surface nevertheless being provided for all individual lenses, or at least fewer light-emitting surfaces than the number of individual lenses present. However, each individual lens of the lens arrangement is usually assigned its own area of the light-receiving surface and its own area of the light-emitting surface.

Advantageously, any and all patterns may be applied to the light-emitting surface of the lens arrangement, or introduced into the light-emitting surface. These patterns are, for example, company names, seals, or logos of the manufacturer of the headlight or light, or of the vehicle. Essentially, the patterns may be applied two-dimensionally to the light-emitting surface as a color application, as appropriately contoured coverings, or in other ways. Alternatively, the patterns may also essentially be configured three-dimensionally and be introduced into the light-emitting surface by a wearing away of material (for example, through etching) or by an application of additional material. The three-dimensional patterns are achieved by wearing away or applying very thin material layers, so that despite the three-dimensional patterns the curve of the light-emitting surface according to the present invention is maintained without breaks or steps. The three-dimensional patterns may also be optically emphasized through color or in other ways. The patterns may be applied or introduced in an area of the light-emitting surface that is assigned to one individual lens and through which light passes during the operation of the light source that is assigned to the individual lens. In this case, the corresponding area of the light-receiving surface should be adjusted accordingly, so that the individual lens provides the stipulated projection characteristics in spite of the pattern. Alternatively or in addition, the patterns can also be applied or introduced on the areas of the light-emitting surface that are not assigned to any of the individual lenses and through which no light, or hardly any light, passes.

According to another advantageous refinement of the present invention, it is proposed that a plurality of light sources of the headlight or light be assigned to the individual lenses of the lens arrangement. It is conceivable that the identical type of light source is assigned to all individual lenses of the lens arrangement. However, different types of light sources are preferably assigned to the individual lenses. Examples of potential light sources are incandescent bulbs, gas discharge lamps, light-emitting diodes (LEDs), and light decoupling surfaces of waveguides.

According to another preferred embodiment of the present invention, it is proposed that each of the individual lenses be assigned its own light source.

According to still another advantageous refinement of the present invention, it is proposed that a plurality of reflectors of the headlight or light be assigned to the individual lenses of the lens arrangement. Each of the individual lenses is preferably assigned its own reflector. The reflectors of the headlight can be integral components of a reflector arrangement, or they can be configured as separate reflectors. The reflectors can be shaped in different ways; specifically, the reflectors can have an ellipsoidal or paraboloidal shape, or one that slightly deviates therefrom. When a multiplicity of LEDs or light decoupling surfaces of waveguides are used as the light source, it is even possible inder certain circumstances to omit a reflector.

According to yet another preferred embodiment of the present invention, it is proposed that the lens arrangement be configured as a cover disk of the headlight or light. For this purpose, the light-emitting surface of the lens arrangement is shaped such that, when the headlight or light is installed, it essentially terminates flush with the body of the vehicle. The lens arrangement is placed in front onto an opening of a headlight housing or a light housing and is secured thereto, for example, using glue. Only through a smooth, flat, and optically neutral configuration of the light-emitting surface of the lens arrangement as provided in the present invention can the lens arrangement take on the function of the cover disk. In this way, the cover disk becomes superfluous, and the manufacturing costs for the headlight or light can be reduced. Another result is the reduced depth of the headlight or light, therefore requiring a flatter installation space within the vehicle.

As another approach to the objective of the present invention, a motor vehicle headlight or light of the type cited above is proposed in which the lens arrangement is configured as a lens arrangement according to the present invention. Advantageously, the lens arrangement functions in the headlight or light as a cover disk.

### DRAWINGS

Further features, application possibilities, and advantages of the present invention will become apparent from the following description of exemplary embodiments of the present invention, which are shown in the drawing. In this context, all of the described or represented features alone or in any combination constitute the subject matter of the present invention, irrespective of their summary in the patent claims or their antecedent references, as well as irrespective of their formulation in the description or representation in the drawing. In the drawing:

FIG. 1 depicts a motor vehicle headlight according to the present invention in accordance with a first preferred embodiment, in a sectional view from above;

FIG. 2 depicts a lens arrangement according to the present invention in a view from the front of a light-emitting surface of the lens arrangement, according to one preferred embodiment;

FIG. 3 depicts the lens arrangement according to the present invention from FIG. 2, in a view from the rear of a light-receiving surface of the lens arrangement;

FIG. 4 depicts the lens arrangement according to the present invention from FIG. 3, in a sectional view along the line IV-IV;

FIG. 5 depicts the lens arrangement according to the present invention from FIG. 3, having three different light sources;

FIG. 6 depicts a lens arrangement according to the present invention in a view from the rear of a light-receiving surface of the lens arrangement, in accordance with a further embodiment;

FIG. 7 depicts the lens arrangement from FIG. 6 in a sectional view along the line VII-VII; and

FIG. 8 depicts an individual lens in a detail of the lens arrangement according to the present invention, in accordance with FIG. 6.

### DESCRIPTION OF THE EXEMPLARY EMBODIMENTS

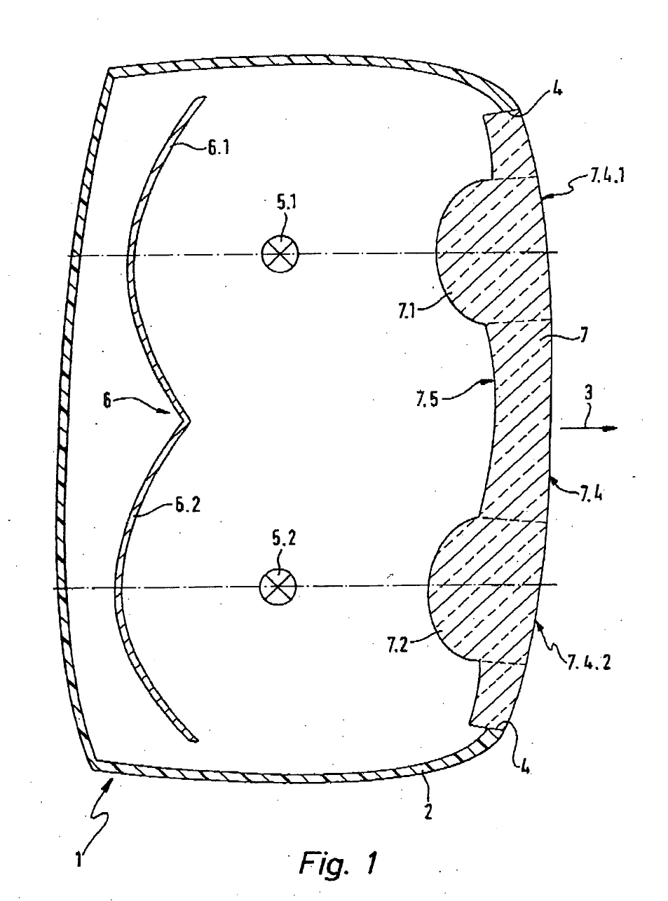

In FIG. 1, a motor vehicle headlight according to the present invention is designated overall with reference number 1. Headlight 1 includes a headlight housing 2, which is preferably made of a plastic material. In light-emitting direction 3, housing 2 has an opening 4. Arranged in the interior of housing 2 are a first light source 5.1 and a first reflector 6.1 as well as a second light source 5.2 and a second reflector 6.2. Both reflectors 6.1 and 6.2 are integral components of a reflector arrangement 6. Obviously, however, reflectors 6.1 and 6.2 can also both be configured as separate, independent reflectors. A lens arrangement 7 according to the present invention is set in opening 4 of headlight housing 2 and is secured therein. Lens arrangement 7 in the present exemplary embodiment includes two individual lenses 7.1 and 7.2. Of course, lens arrangement 7 may also include more than two individual lenses. These lenses do not all have to be next to each other, but rather they may be arranged over each other and/or offset with respect to each other. First individual lens 7.1 is assigned to first light source 5.1 and first reflector 6.1. Similarly, second individual lens 7.2 is assigned to second light source 5.2 and second reflector 6.2. Light that is emitted by first light source 5.1 and reflected by first reflector 6.1 in light-emitting direction 3 passes for the most part through individual lens 7.1, so that a light distribution results that corresponds to the projection characteristics of individual lens 7.1. Similarly, light that is emitted by light source 5.2 and reflected by reflector 6.2 for the most part passes through second individual lens 7.2, so that a light distribution results that corresponds to the projection characteristics of individual lens 7.2.

In the lens arrangement according to the present invention, an external light-emitting surface 7.3 is configured such that it has a constant curvature, i.e., light-emitting surface 7.4 has neither breaks nor creases. In the exemplary embodiment shown in FIG. 1, the curvature of light-emitting surface 7.4 does not even have any points of inflection, so that a light-emitting surface 7.4 of lens arrangement 7 results that has an essentially uniform curve.

A light-receiving surface 7.5 of lens arrangement 7 is configured such that, in combination with light-emitting surface 7.4, the specifiable projection characteristics of individual lenses 7.1 and 7.2 result. In the present exemplary embodiment, light-receiving surface 7.5 in the area of individual lenses 7.1 and 7.2 is curved in a convex manner from the point of view of the headlight interior.

In the exemplary embodiment shown in FIG. 1, lens arrangement 7 simultaneously functions as the cover disk of headlight 1. For this purpose, the exterior contour of lens arrangement 7 must be adjusted to the interior contour of opening 4 in headlight housing 2. Lens arrangement 7 is set into opening 4 and is secured there, preferably through an adhesive or weld. In a headlight 1 that is configured in this manner, one component may be omitted in the form of the cover disk and one working step in the assembly process may be omitted in the form of placing and securing the cover disk in opening 4.

However, the present invention of course also includes such headlights 1 in which lens arrangement 7 is configured separately from the cover disk. In this case, lens arrangement 7 is arranged within the interior of headlight 1 and, instead of lens arrangement 7, a separate cover disk is set in opening 4 and secured there. In addition, the present invention, instead of vehicle headlight 1 as shown in FIG. 1, may also be used for any motor vehicle light, especially for a taillight. With regard to design, the light would essentially have the design shown in FIG. 1. The above statements with regard to motor vehicle headlight 1 apply to equally to a motor vehicle light.

In the exemplary embodiment shown in FIG. 1, reflectors 6.1 and 6.2 are assigned to individual lenses 7.1 and 7.2. This applies especially when light sources 5.1 and 5.2 are configured as incandescent bulbs or as gas discharge lamps. In the event that one of light sources 5.1 or 5.2 includes, for example, light-emitting diodes (LEDs) or light decoupling surfaces of waveguides, it would be possible under certain circumstances to omit the reflector of that light source.

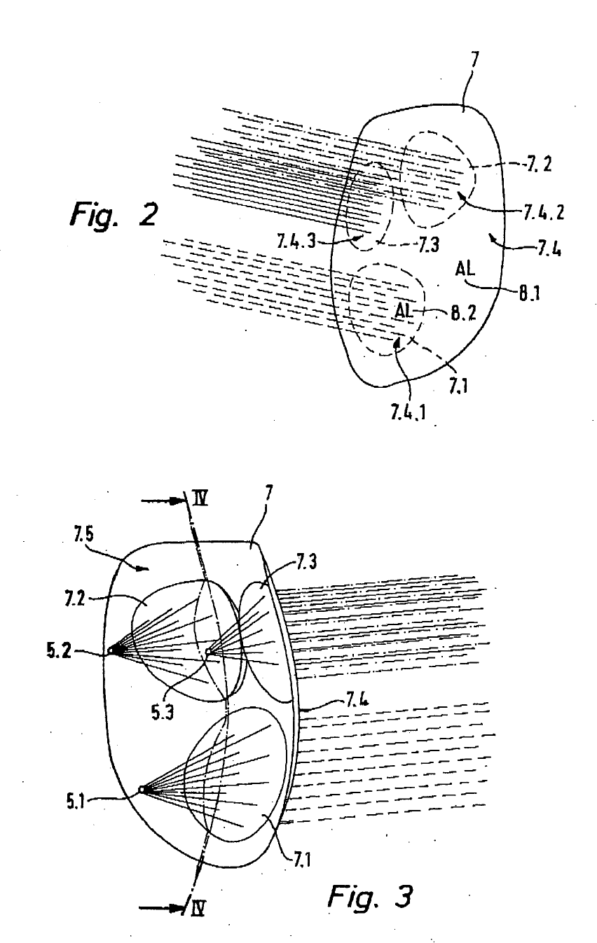

FIG. 2 shows a lens arrangement 7 according to the present invention in accordance with another preferred embodiment, depicted in a perspective view. More precisely, FIG. 2 shows light-emitting surface 7.4 of lens arrangement 7. Lens arrangement 7 from FIG. 2 includes three individual lenses 7.1, 7.2, and 7.3, which are only sketched using a dotted line, since they can scarcely or not at all be recognized on light-emitting surface 7.4. The areas of light-emitting surface 7.4 corresponding to individual lenses 7.1 through 7.3 are indicated as 7.4.1, 7.4.2, and 7.4.3. The light beams passing through area 7.4.1 of light-emitting surface 7.4 corresponding to individual lens 7.1 are indicated using dotted lines. Similarly, the light beams passing through area 7.4.2 of light-emitting surface 7.4 corresponding to second individual lens 7.2 are indicated using a dot-dash line. The light beams passing through area 7.4.3 of light-emitting surface 7.4 corresponding to third individual lens 7.3 are indicated using a solid line. In the exemplary embodiment from FIG. 2, a company insignia of the applicant, Automotive Light (AL), is applied to light-emitting surface 7.4 or is introduced into light-emitting surface 7.4. A first company insignia 8.1 is arranged in an area of light-emitting surface 7.4 that is outside of areas 7.4.1 through 7.4.3 of light-emitting surface 7.4 that are assigned to individual lenses 7.1 through 7.3. The projection characteristics of individual lenses 7.1 through 7.3 are not at all impaired by pattern 8.1, or are so only to a negligible degree. Pattern 8.2 is arranged in area 7.4.1 of light-emitting surface 7.4, which is assigned to individual lens 7.1. The projection characteristics of individual lens 7.1 may be impaired under certain circumstances by pattern 8.2. However, this is compensated for by the fact that the corresponding area of light-receiving surface 7.5 is configured such that, in combination with area 7.4.1 of light-emitting surface 7.4 and despite this pattern, the specified projection characteristics of individual lens 7.1 result.

FIG. 3 shows lens arrangement 7 from FIG. 2 also in a perspective view, but in the direction of view of light-receiving surface 7.5. It can clearly be seen that light-receiving surface 7.5 in the area of individual lenses 7.1 through 7.3 is curved in a convex manner from the point of view of the headlight interior. Of course, the areas of light-receiving surface 7.5 assigned to individual lenses 7.1 through 7.3 may also be configured in a different manner so long as the specified projection characteristics of individual lenses 7.1 through 7.3 are achieved and light-emitting surface 7.4 of lens arrangement 7 has a constant curvature, preferably a curvature without points of inflection. In the exemplary embodiment shown in FIG. 3, each individual lens 7.1 through 7.3 is assigned its own light source 5.1 through 5.3, the light sources being symbolized by dots. Light sources 5.1 through 5.3 may be configured in any and all ways, and specifically incandescent bulbs, gas discharge lamps, light-emitting diodes and/or light decoupling surfaces of waveguides are conceivable. Light sources 5.1 through 5.3 that are assigned to individual lenses 7.1 through 7.3 of lens arrangement 7 may be identical or of different types.

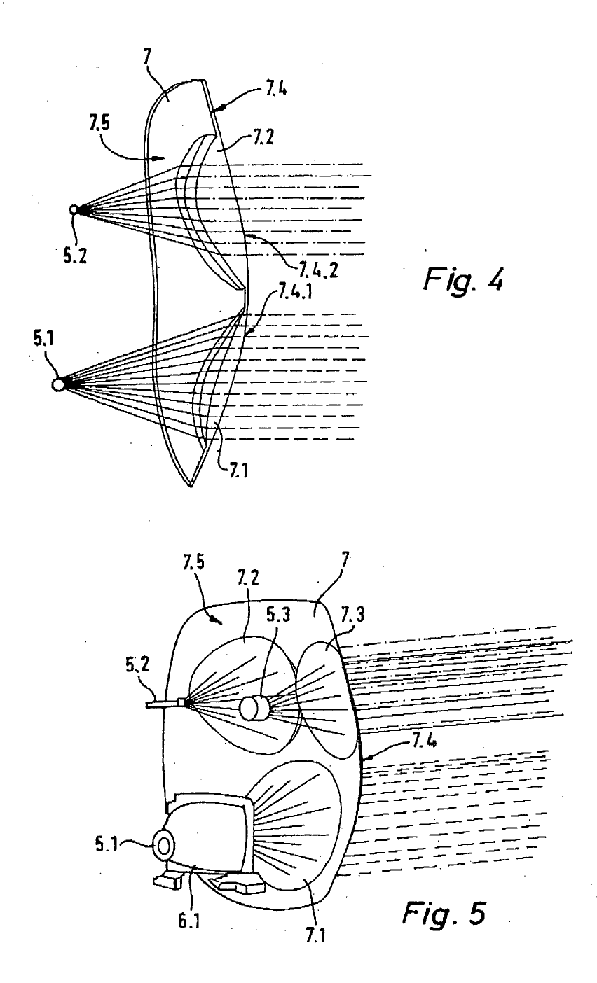

FIG. 4 shows lens arrangement 7 from FIG. 3 in a sectional view along the line IV-IV. In this context, it is especially easy to recognize the constant curvature of light-emitting surface 7.4 as well as the particular configuration of the areas of light-receiving surface 7.5 that are assigned to individual lenses 7.1 and 7.2. Individual lenses 7.1 and 7.2 are configured as so-called free-form lenses.

FIG. 5 depicts lens arrangement 7 from FIG. 3, light sources 5.1 through 5.3 being configured in different ways. Specifically, a polyellipsoidal headlight (PES) system is assigned to individual lens 7.1, the system including an essentially ellipsoidal reflector 6.1 and a light source 5.1 that is arranged in the crown of reflector 6.1, the light source preferably being configured as an incandescent bulb or a gas discharge lamp. Light source 5.2 is configured as a light-emitting diode, and light source 5.3 is configured as a decoupling surface of one or more waveguides (for example, of a fiber optics module).

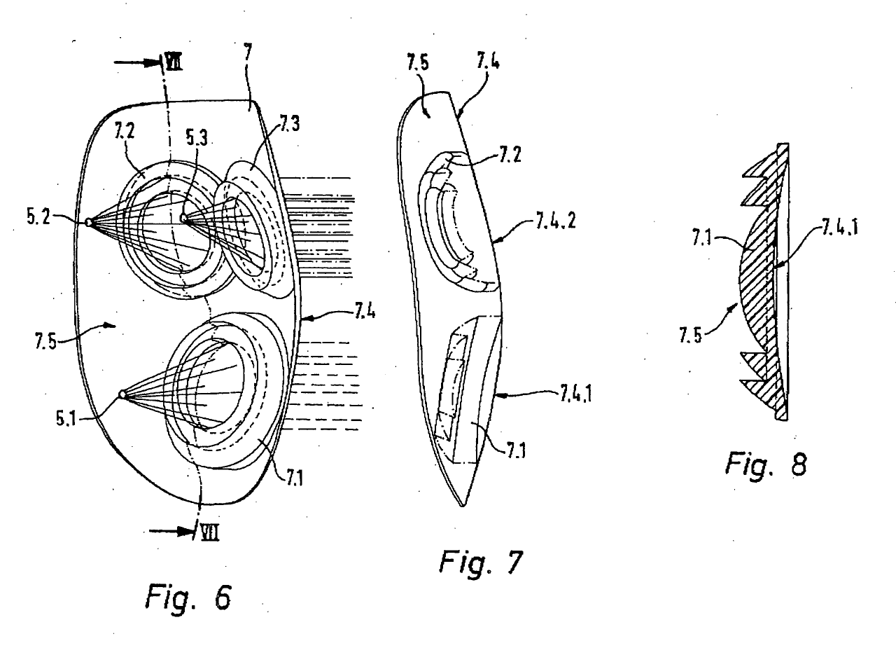

FIGS. 6 and 7 show a further embodiment of a lens arrangement 7 according to the present invention, in which individual lenses 7.1 through 7.3 are configured as free-form lenses having Fresnel optics. Using this type of configuration of individual lenses 7.1 through 7.3, the strength (thickness) of lens arrangement 7 can be reduced, as a result of which additional installation space and material savings can be gained.

FIG. 8 shows individual lens 7.1 of the embodiment according to FIG. 6 and 7 in a detail and sectional view. The minimal thickness of lens 7. 1, configured as a Fresnel lens, may be seen especially clearly.

1-12. (canceled)

13. A lens arrangement (7) for a motor vehicle headlight (1) or for a motor vehicle light having at least one light source (5.1, 5.2, 5.3) that in the switched-on state emits light, the lens arrangement (7) including a plurality of individual lenses (7.1, 7.2, 7.3) that are arranged in the beam path of the light, wherein a light-emitting surface (7.4) of the lens arrangement (7) has a constant curvature.

14. The lens arrangement (7) as recited in claim 13, wherein the curvature of the light-emitting surface (7.4) has no points of inflection.

15. The lens arrangement (7) as recited in claim 13 wherein a light-receiving surface (7.5) of the lens arrangement (7) is configured such that, in combination with the light-emitting surface (7.4), specifiable projection characteristics of the individual lenses (7.1, 7.2, 7.3) result.

16. The lens arrangement (7) as recited in any of claim 13, wherein any and all patterns (8.1, 8.2) may be applied to the light-emitting surface (7.4) or may be introduced into the light-emitting surface (7.4).

17. The lens arrangement (7) as recited in any of claim 13, wherein a plurality of light sources (5.1, 5.2, 5.3) of the headlight (1) or light are assigned to the individual lenses (7.1, 7.2, 7.3) of the lens arrangement (7).

18. The lens arrangement (7) as recited in claim 17, wherein different types of light sources (5.1, 5.2, 5.3) are assigned to the individual lenses (7.1, 7.2, 7.3).

19. The lens arrangement (7) as recited in claim 17, wherein each of the individual lenses (7.1, 7.2, 7.3) is assigned its own light source (5.1, 5.2, 5.3).

20. The lens arrangement (7) as recited in any of claim 13, wherein a plurality of reflectors (6.1, 6.2) of the headlight (1) or light are assigned to the individual lenses (7.1, 7.2, 7.3).

21. The lens arrangement (7) as recited in claim 20, wherein each of the individual lenses (7.1, 7.2, 7.3) is assigned its own reflector (6.1, 6.2).

22. The lens arrangement (7) as recited in any of claim 13, wherein the lens arrangement (7) is configured as a cover disk of the headlight (1) or light.

23. A motor vehicle headlight (1) having at least one light source (5.1, 5.2, 5.3) that in the switched-on state emits light and having a lens arrangement (7) which includes a plurality of individual lenses (7.1, 7.2, 7.3) that are arranged in the beam path of the light, wherein the lens arrangement (7) has a constant curvature.
